(19) United States
(12) Patent Application Publication
(10) Pub. No.: US 2018/0304469 A1
(43) Pub. Date: Oct. 25, 2018

(54) ROBOT SYSTEM

(71) Applicant: OMRON Corporation, KYOTO (JP)

(72) Inventors: Toshiyuki HIGUCHI, Kusatsu-shi (JP); Yoshiharu TANI, Kusatsu-Shi (JP); Tetsuya AKAGI, Kyoto-shi (JP)

(73) Assignee: OMRON Corporation, KYOTO (JP)

(21) Appl. No.: 15/890,351

(22) Filed: Feb. 7, 2018

(30) Foreign Application Priority Data
Apr. 21, 2017 (JP) 2017-084358

(51) Int. Cl. B25J 9/16; G08B 21/02; G06K 9/00

(52) U.S. Cl. CPC B25J 9/1697; G08B 21/02; Y10S 901/47; B25J 9/1674; Y10S 901/09; G06K 9/00342

(57) ABSTRACT

There is provided a robot system that maintains productivity with high safety and with high operation efficiency. A robot system includes an arm operation control unit configured to control an operation of an arm and a moving subject detection unit configured to detect whether a moving subject is present in an operation direction region of the arm. When the moving subject detection unit has detected the moving subject, the arm operation control unit operates the arm at an operation speed that is different from an operation speed of the arm when no moving subject has been detected.

### CROSS-REFERENCE TO RELATED APPLICATION

This application claims the priority benefit of Japan application serial no. 2017-084358, filed on Apr. 21, 2017. The entirety of the above-mentioned patent application is hereby incorporated by reference herein and made a part of this specification.

### BACKGROUND

### Technical Field

The disclosure relates to a robot system that is operated by a program.

### Description of Related Art

Robot systems including an arm that can be operated to perform an operation are known in the related art. For such robot systems, techniques for preventing an arm from colliding with other operators during operation are known. For example, Japanese Patent Application Laid-Open (JP-A) No. 2014-176932 (published Sep. 25, 2014) discloses a robot system in which, regarding a predetermined range region set around a robot according to an operation speed of the robot, when it is detected that a moving subject is present in the region, an abnormality is determined, and a process (stopping an operation of a robot, transmitting an alarm, and reducing an operation speed of an operation arm) is performed according to the abnormality determination. Japanese Patent Application Laid-Open (JP-A) No. 2015-526309 (published Sep. 10, 2015) discloses a robot that generally operates at a speed that is equal to or lower than a first threshold value, and when the torso or head of a human is detected in a critical region defined in a detection region set around the robot, the robot operates at a speed that is equal to or lower than a second threshold value.

In all of the techniques of the related arts described above, when a moving subject is detected in a region set around the robot, an operation of the arm is set to be different from usual, collision of the moving subject with the arm being prevented. However, in such techniques of the related art, since there is a risk of a region in which collision does not actually occur being determined as a determination target, there is a problem of operation efficiency being lowered.

An embodiment of the disclosure is to provide a robot system that maintains productivity with high safety and with high operation efficiency.

### SUMMARY

A robot system according to an embodiment of the disclosure includes an arm operation control unit configured to control an operation of an arm; and a moving subject detection unit configured to detect whether a moving subject is present in an operation direction region set according to an operation direction of the arm. When the moving subject detection unit has detected the moving subject, the arm operation control unit operates the arm at an operation speed that is different from an operation speed of the arm when no moving subject has been detected.

According to an embodiment of the disclosure, it is possible to provide a robot system that maintains productivity with high safety and with high operation efficiency.

### BRIEF DESCRIPTION OF THE DRAWINGS

FIG. 1 is a block diagram showing an example of a main part configuration of a robot system according to Embodiment 1 of the disclosure.

FIG. 2 is a schematic diagram showing an overview of the robot system according to Embodiment 1 of the disclosure.

FIG. 3 is a bird's-eye view of the robot system according to Embodiment 1 of the disclosure when viewed from above.

FIG. 4 is a bird's-eye view of the robot system according to Embodiment 1 of the disclosure when viewed from above.

FIG. 5 is a flowchart showing an example of a process performed by the robot system according to Embodiment 1 of the disclosure.

FIG. 6 is a flowchart showing an example of a process performed by a robot system according to Embodiment 2 of the disclosure.

FIG. 7A and FIG. 7B show bird's-eye views of a robot system according to Embodiment 3 of the disclosure when viewed from above, FIG. 7A shows a case in which an operator is present in a robot operation range in an operation direction of an operation arm, and FIG. 7B shows a case in which an operator is present outside a robot operation range in an operation direction of an operation arm.

FIG. 8 is a flowchart showing an example of a process performed by a robot system according to Embodiment 3 of the disclosure.

FIG. 9A and FIG. 9B show bird's-eye views of a robot system according to Embodiment 4 of the disclosure when viewed from above, FIG. 9A shows a case in which an operator is present in a robot operation range in an operation direction of an operation arm and FIG. 9B shows a case in which an operator is present outside a robot operation range in an operation direction of an operation arm.

FIG. 10 is a flowchart showing an example of a process performed by a robot system according to Embodiment 4 of the disclosure.

### DESCRIPTION OF THE EMBODIMENTS

In the robot system according to an embodiment of the disclosure, the operation direction region may be set such that it includes a target position of at least one arm described in a program that defines an operation of the arm.

In the robot system according to an embodiment of the disclosure, the operation direction region may be set by prefetching a target position of at least one arm described in the program that defines an operation of the arm from a current step of a program that is executing an operation of the arm.

The robot system according to an embodiment of the disclosure further includes a warning transmission unit configured to transmit a warning to the outside, and when the moving subject detection unit has detected the moving subject, the warning transmission unit may transmit the warning.

In the robot system according to an embodiment of the disclosure, when the moving subject detection unit has detected the moving subject, the arm operation control unit may stop an operation of the arm

In the robot system according to an embodiment of the disclosure, when an operation of the arm is stopped and then the moving subject detection unit has not detected the moving subject in an operation direction of the arm, the arm operation control unit may restart an operation of the arm in the operation direction.

The robot system according to an embodiment of the disclosure further includes an arm operation range detection unit configured to detect an operation range of the arm, and the moving subject detection unit may detect whether the moving subject is present in the operation direction region and in an operation range of the arm.

The robot system according to an embodiment of the disclosure further includes a moving subject position range monitoring unit configured to monitor whether the moving subject is present in a moving subject position range set outside an operation range of the arm, and when the moving subject position range monitoring unit has not detected the moving subject, the arm operation control unit may operate the arm at an operation speed that is different from an operation speed of the arm when the moving subject position range monitoring unit has detected the moving subject.

In the robot system according to an embodiment of the disclosure, the moving subject detection unit may detect whether a moving subject is present in the operation direction region set according to an operation direction of the arm on the basis of a captured image captured by a camera.

### Embodiment 1

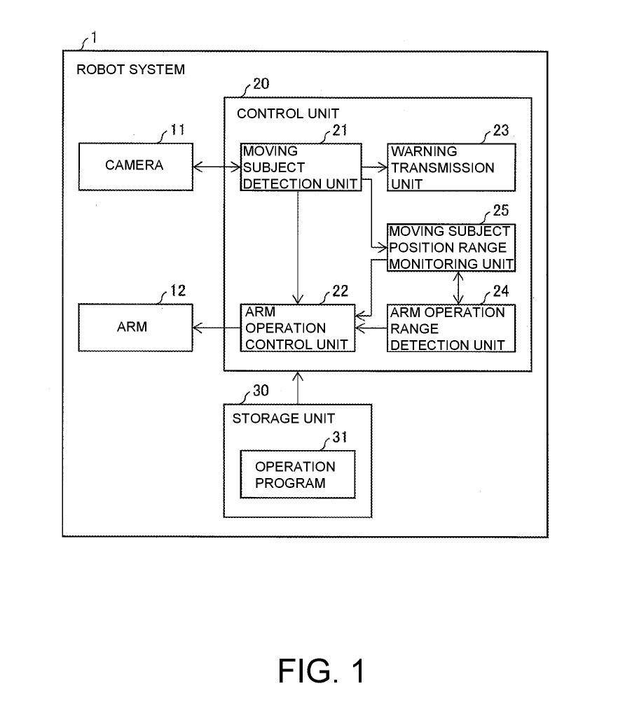

Embodiments of the disclosure will be described below in detail with reference to FIGS. 1 to 5.

### Configuration of Robot System

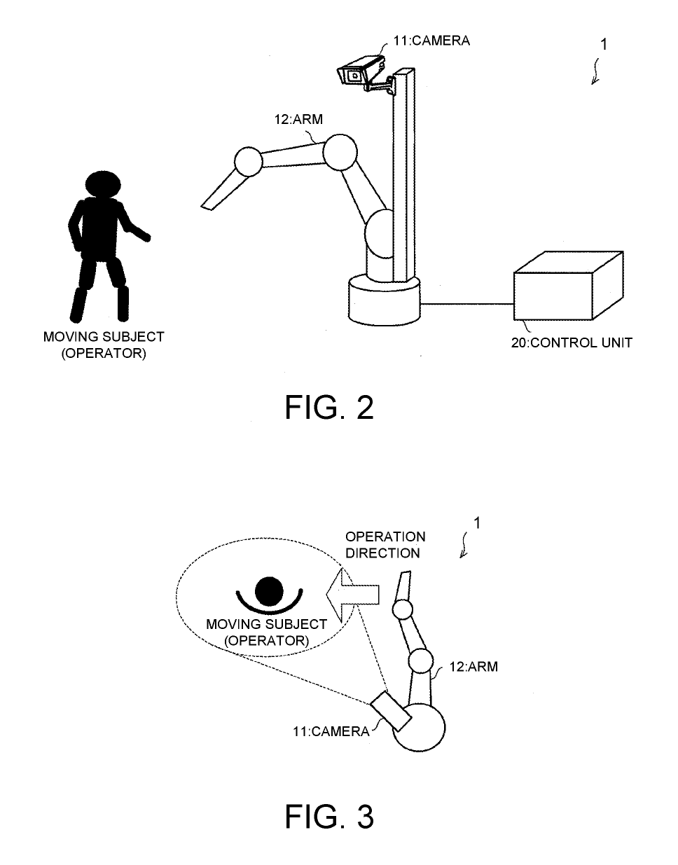

An overview and a configuration of a robot system 1 according to the present embodiment will be described with reference to FIGS. 1 and 2. FIG. 1 is a block diagram showing an example of a main part configuration of the robot system 1. FIG. 2 is a schematic diagram showing an overview of the robot system 1.

First, an overview of the robot system 1 will be described with reference to FIG. 2. In the shown example, the robot system can image a moving subject such as an operator using a camera 11 fixed to a supporting column that extends from a pedestal. In addition, the robot system 1 can be operated by operating an arm 12 supported on the pedestal. The above process is controlled by a control unit 20 included in the robot system 1.

Next, a configuration of the robot system 1 will be described with reference to FIG. 1. In the shown example, the robot system 1 includes the camera 11, the arm 12, the control unit 20, and a storage unit 30. The control unit 20 includes a moving subject detection unit 21 and an arm operation control unit 22. In addition, the storage unit 30 includes an operation program 31. Here, in FIG. 1, in addition to this configuration, a warning transmission unit 23, an arm operation range detection unit 24, and a moving subject position range monitoring unit 25 are shown. However, such units are not necessary in the present embodiment. Details of such units will be described in Embodiments 2 to 4 to be described below.

The robot system 1 can operate units according to the operation program 31. More specifically, the robot system 1 can operate the camera 11 and the arm 12 according to the operation program 31.

Here, although not shown, the control unit 20 may be connected to an upper-level device, for example, a controller, through communication, and may change operation content in the operation program 31 according to an instruction from the controller. In addition, an actual operation state of the arm 12, imaging data of the camera 11, and the like may be transmitted to the controller.

When the arm 12 operates, the robot system 1 can set an operation direction region according to an operation direction of the arm 12 and image the operation direction region using the camera 11. Here, the operation direction region is a region set in a direction in which the arm 12 operates, and when a moving subject is present in the operation direction region, the operation direction region is a predetermined region in which the moving subject may collide with the arm 12. In other words, the operation direction region is a region set for the arm 12 in a direction (operation side) in which the arm 12 has started operating. That is, when the arm 12 operates, the operation direction region includes a range in which the arm 12 operates from a current position set by the control unit 20 to a target position. On the other hand, a region on the side opposite to a direction in which the arm 12 has started operating is not included. In addition, the control unit 20 may continuously set at least one target position. In this case, the operation direction region may be set such that it includes a target position of at least one arm 12 described in the operation program 31. In this case, the control unit 20 prefetches and sets a target position of at least one arm 12 described in the operation program 31 from a current step of the operation program 31 that executes an operation of the arm 12. The robot system 1 determines whether a moving subject such as an operator is present in the operation direction region from a captured image captured by the camera 11. When it is determined that a moving subject is present, the robot system 1 can operate the arm 12 at an operation speed that is different from an operation speed when it is determined that the moving subject is not present in the operation direction region.

The camera 11 can operate according to the operation program 31. The camera 11 can image the operation direction region of the arm 12 according to an instruction from the control unit 20 that has read the operation program 31 and transmit the captured image to the moving subject detection unit 21. In the shown example, while there is a configuration in which the camera 11 is included in the robot system 1, any configuration may be used as long as the captured image obtained by imaging the operation direction region of the arm 12 can be transmitted to the moving subject detection unit 21. For example, the robot system 1 may have a configuration in which a captured image captured by an external camera is acquired through communication.

The arm 12 is a part that the robot system 1 uses for operation. The arm 12 may be, for example, a flexible arm including plurality of joints. The arm 12 can operate under control of the arm operation control unit 22.

The storage unit 30 can store various types of data handled by the robot system 1. In the shown example, the storage unit 30 includes at least the operation program 31.

The operation program 31 is a program in which there is description of a process for operation of the robot system 1. The operation program 31 can be read by the control unit 20 and the control unit 20 can operate units according to the description content.

The control unit 20 collectively controls units of the robot system 1. The control unit 20 can determine an operation direction of the arm 12. When an operation direction of the arm 12 is determined, the control unit 20 can cause the moving subject detection unit 21 to check whether a moving subject such as an operator is present in the operation direction region. The control unit 20 can instruct the arm operation control unit 22 to operate the arm 12 in an operation direction. Here, in FIG. 1, there is a configuration in which the control unit 20 is included in the robot system 1, but it may be disposed outside a casing as shown in FIG. 2 as long as there is a configuration in which the camera 11 and the arm 12 can be operated.

The moving subject detection unit 21 can detect whether a moving subject such as an operator is present in the operation direction region according to an instruction of the control unit 20. The moving subject detection unit 21 can transmit the detection result to the arm operation control unit 22. Here, as long as the moving subject detection unit 21 can detect whether a moving subject is present, an object used for detection is not necessarily limited to an image captured by the camera 11. For example, using a laser scanner that scans a predetermined region using a laser beam and detects inclusion of a moving subject according to whether there is reflected light, a detection result of the laser scanner may be transmitted to the arm operation control unit 22.

The arm operation control unit 22 can operate the arm 12 according to an instruction from the control unit 20. The arm operation control unit 22 can vary an operation speed of the arm 12 according to whether the moving subject detection unit 21 has detected a moving subject. More specifically, when the moving subject detection unit 21 has detected the moving subject, the arm operation control unit 22 can operate the arm 12 at an operation speed that is different from an operation speed of the arm 12 when no moving subject has been detected.

### Positional Relationship Between Robot System and Moving Subject

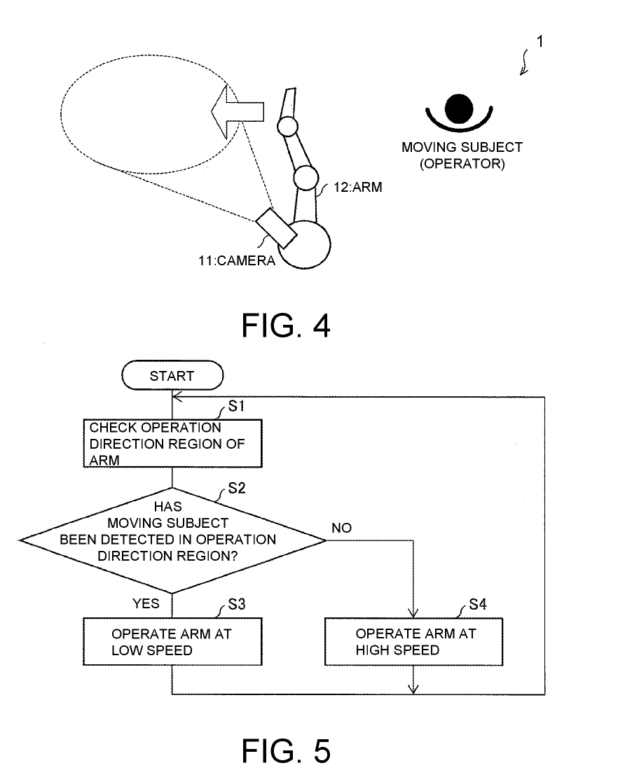

A positional relationship between the robot system 1 and a moving subject in a robot system according to the present embodiment will be described with reference to FIGS. 3 and 4. FIGS. 3 and 4 are bird's-eye views of a robot system when viewed from above. Here, in the shown example, while an operator is described as a moving subject, the disclosure is not necessarily limited thereto.

FIG. 3 shows a case in which an operator is present in an operation direction region set in an operation direction of the arm 12. When the camera 11 images the operation direction region, since the operator is included in the captured image, the moving subject detection unit 21 can detect the presence of the operator. In this case, when the arm 12 operates, there is a risk of the arm 12 colliding with the operator. Therefore, for example, the arm operation control unit 22 secures a time margin for the operator to move by operating the arm 12 at a speed lower than a normal operation speed and can reduce an impact applied to a victim when the arm 12 collides with the operator.

FIG. 4 shows a case in which no operator is present in an operation direction region set in an operation direction of the arm 12. Therefore, when the camera images the operation direction region, the operator is not included in the captured image. In this case, even if the arm 12 operates, the arm 12 does not collide with the operator. Therefore, for example, when the arm operation control unit 22 causes the arm 12 to operate at a normal operation speed, it is possible to increase operation efficiency.

### Flow of Processes

A flow of processes performed by the robot system 1 according to the present embodiment will be described with reference to FIG. 5. FIG. 5 is a flowchart showing an example of a process performed by the robot system 1.

First, when the arm operation control unit 22 determines the arm 12 is to be operated and starts the operation, the control unit 20 sets an operation direction region in an operation direction of the arm 12, and then checks whether a moving subject is present in the operation direction region of the arm using the moving subject detection unit 21 (S1). Then, the control unit 20 determines whether the moving subject detection unit 21 has detected a moving subject in the operation direction region of the arm (S2). When it is determined that a moving subject has been detected (YES in S2), the arm operation control unit 22 operates the arm 12 at a low speed (S3). After S3, the arm operation control unit 22 waits until the next operation of the arm 12 is input.

On the other hand, when it is determined in S2 that no moving subject has been detected in the operation direction region (NO in S2), the arm operation control unit 22 operates the arm 12 at a high speed in the same manner as usual (S4). After S4, the arm operation control unit 22 waits until the next operation of the arm 12 is input.

According to the above process, when a moving subject is present, for example, an operator, in a direction in which the arm 12 moves, the robot system 1 can operate the arm at an operation speed that is different from that when no moving subject is present. Therefore, it is possible to set a time margin for the operator to move from the operation direction region, but when no operator is present in the operation direction region, it is possible to operate the arm at a normal speed. Therefore, it is possible to provide a robot system that maintains productivity with high safety and with high operation efficiency.

Here, in the above description, the robot system 1 is configured to detect a moving subject using a captured image captured by one camera 11. However, for example, the robot system 1 may detect a moving subject by combining captured images captured by a plurality of cameras. In this case, the control unit 20 may set a height in the operation direction region using a plurality of captured images. That is, the control unit 20 may set the operation direction region according to the height of the arm 12 with respect to the ground.

### Embodiment 2

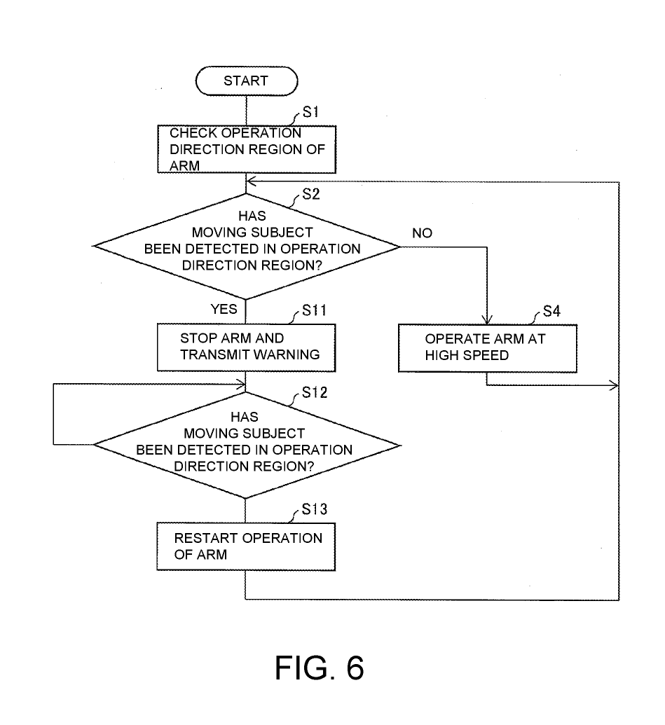

Embodiment 2 of the disclosure will be described below with reference to FIGS. 1 and 6. Here, for convenience of description, units having the same functions as the units described in the above embodiment will be denoted with the same reference numerals and descriptions thereof will be omitted.

### Configuration of Robot System

A configuration of the robot system 1 according to the present embodiment will be described with reference to FIG. 1.

A basic configuration of the robot system 1 is the same as that of Embodiment 1, but a part of the configuration is different. In the present embodiment, the robot system 1 further includes the warning transmission unit 23.

When it is detected that a moving subject such as an operator is present in the operation direction region, the robot system 1 can transmit a warning using the warning transmission unit 23. In addition, when the moving subject detection unit 21 detects that a moving subject such as an operator is present in the operation direction region of the arm 12, the robot system 1 can stop an operation of the arm 12. In addition, when an operation of the arm 12 is stopped and then the moving subject detection unit 21 does not detect a moving subject such as an operator in the operation direction region of the arm 12, the robot system 1 can restart an operation of the aim 12 in an initially set operation direction.

When the moving subject detection unit 21 detects a moving subject such as an operator in the operation direction region of the arm 12, the warning transmission unit 23 can transmit a warning to the outside. Here, the warning may have any form as long as the moving subject can detect the warning. For example, a sound warning may be used or a light or text warning may be used

### Flow of Processes

A flow of processes performed by the robot system 1 according to the present embodiment will be described with reference to FIG. 6. FIG. 6 is a flowchart showing an example of a flow of processes performed by the robot system 1.

The processes of S1 and S2 are the same as those in Embodiment 1.

In S2, when it is determined that a moving subject has been detected (YES in S2), the arm operation control unit 22 stops an operation of the arm 12 and the warning transmission unit 23 transmits a warning (S11). Then, the control unit 20 determines whether a moving subject has been detected in the operation direction region of the arm 12 (S12). When it is determined that no moving subject has been detected in the operation direction region (NO in S12), the arm operation control unit 22 restarts an operation of the arm 12. On the other hand, when it is determined in S12 that a moving subject has been detected in the operation direction region (YES in S12), the arm operation control unit 22 waits until no moving subject has been detected in the operation direction region.

On the other hand, when it is determined in S2 that no moving subject has been detected in the operation direction region (NO in S2), the arm operation control unit 22 operates the arm 12 at a high speed in the same manner as in Embodiment 1 (S4). After S4, the arm operation control unit 22 waits until the next operation of the arm 12 is input.

According to the above process, when a moving subject such as an operator is present in a direction in which the arm 12 moves, the robot system 1 transmits a warning to the outside and stops an operation of the arm 12. Therefore, the operator can move from a position in an operation direction of the arm on the basis of the warning. In addition, when it is detected that a moving subject such as an operator is away from the position in an operation direction of the arm 12, the robot system 1 restarts an operation of the arm 12. Therefore, it is possible to provide the robot system 1 that has high safety and also continues an operation and obtains high operation efficiency.

Here, in the above process, the arm operation control unit 22 is configured to stop an operation of the arm 12 when a moving subject is detected in the operation direction region of the arm 12. However, the arm operation control unit 22 may have any configuration as long as it can curb collision of the arm 12 with a moving subject. For example, the arm operation control unit 22 may be configured to, when the moving subject detection unit 21 detects a moving subject, operate the arm 12 at a different operation speed, and then when the moving subject detection unit 21 detects no moving subject, change an operation speed of the arm 12 to a speed before change. In addition, the arm operation control unit 22 may perform only control of an operation of the arm 12 without causing the warning transmission unit 23 to transmit a warning.

### Embodiment 3

Embodiment 3 of the disclosure will be described below with reference to FIGS. 1, 7A, 7B and 8. Here, for convenience of description, units having the same functions as the units described in the above embodiment will be denoted with the same reference numerals and descriptions thereof will be omitted.

### Configuration of Robot System

A configuration of the robot system 1 according to the present embodiment will be described with reference to FIG. 1.

A basic configuration of the robot system 1 is the same as that of Embodiment 1, but a part of the configuration is different. In the present embodiment, the robot system 1 further includes the arm operation range detection unit 24.

When the moving subject detection unit 21 detects that a moving subject is present in an operation direction region and in an operation range of the arm 12 detected by the arm operation range detection unit 24, the robot system 1 can operate the arm 12 at an operation speed that is different from a normal speed.

The arm operation range detection unit 24 can detect an operation range in which the arm 12 operates. The operation range may be a maximum range in which the arm 12 can move, and may be a range according to an operation of the arm 12 set by the arm operation control unit 22.

The moving subject detection unit 21 can detect whether a moving subject is present in an operation direction region and an operation range of the arm 12 detected by the arm operation range detection unit 24.

### Positional Relationship Between Operation Direction Region and Operation Range of Arm

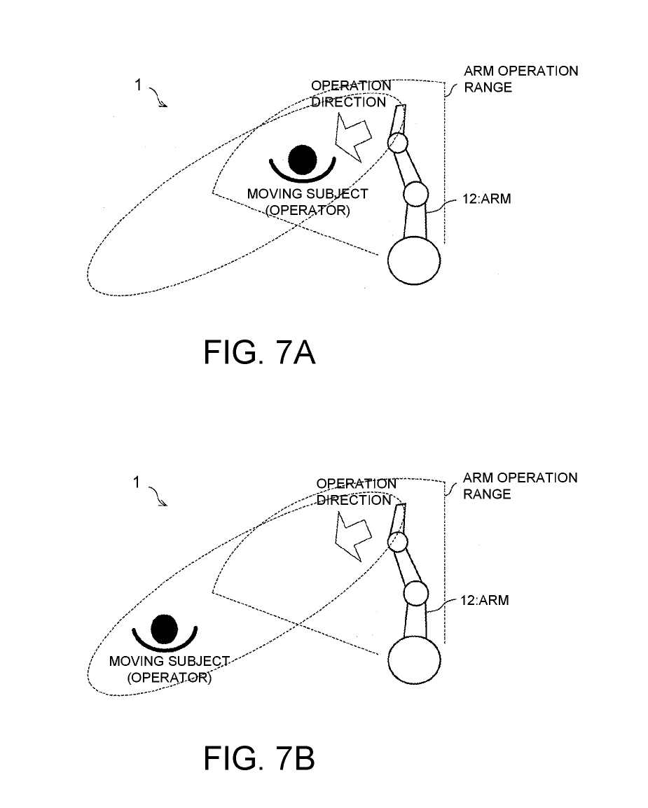

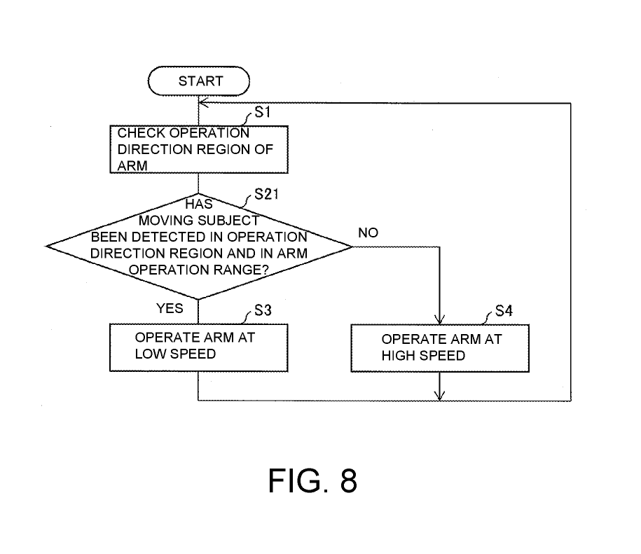

In the present embodiment, a positional relationship between an operation direction region and an operation range of the arm 12 used when the moving subject detection unit 21 detects a moving subject will be described with reference to FIG. 7A and FIG. 7B. FIG. 7A and FIG. 7B shows bird's-eye views of the robot system 1 when viewed from above, FIG. 7A shows a case in which an operator is present in the operation direction region of the arm 12 and in an operation range of the arm 12, and FIG. 7B shows a case in which an operator is present in an operation direction region of the arm 12 and outside an operation range of the arm 12.

In FIG. 7A, the operation direction region is shown as an elliptical region in an operation direction of the arm 12. In addition, the operation range of the arm 12 is shown as a fan-shaped region with a foundation of the robot system 1 as its origin. As shown in the drawing, the operation range of the arm 12 is set such that it partially overlaps the operation direction region. When the moving subject detection unit 21 detects that an operator is present in a region in which the operation direction region overlaps the operation range of the arm 12, the robot system 1 determines that there is a risk of the arm 12 colliding with the operator according to an operation of the arm 12. In this case, the arm operation control unit 22 can set an operation speed of the arm 12 that is different from a normal speed.

FIG. 7B shows a case in which an operator is in a range of an operation direction region but he or she is at a position that is not included in the operation range of the arm 12. When the moving subject detection unit 21 detects an operator present at such a position, the robot system 1 determines that there is no risk of the arm 12 colliding with the operator according to an operation of the arm 12. In this case, the arm operation control unit 22 can operate the arm 12 at a high speed in the same manner as usual.

According to the above configuration, the robot system 1 according to the present embodiment can more accurately determine whether the arm 12 will collide with an operator.

### Flow of Processes

A flow of processes performed by the robot system 1 according to the present embodiment will be described with reference to FIG. 8. FIG. 8 is a flowchart showing an example of a flow of processes performed by the robot system 1.

The process of S1 is the same as that of the above embodiments. After S1, the control unit 20 determines whether the moving subject detection unit 21 has detected a moving subject that is in an operation direction region and in an operation range of the arm (S21). When it is determined that a moving subject has been detected (YES in S21), the arm operation control unit 22 performs the process of S3 in the same manner as in the above embodiment. After S3, the arm operation control unit 22 waits until the next operation of the arm 12 is input.

On the other hand, when it is determined in S21 that no moving subject has been detected (S21), the arm operation control unit 22 performs the process of S4 in the same manner as in the above embodiment. After S4, the arm operation control unit 22 waits until the next operation of the arm 12 is input.

According to the above configuration, when a moving subject such as an operator is present in an operation direction region of the arm 12 and in an operation range of the arm 12, the robot system 1 can operate the arm 12 at an operation speed that is different from an operation speed when no operator is present. When an operator is present in the operation direction region of the arm 12 but he or she is present outside the operation range, if the arm 12 operates, since there is no risk of the operator colliding with the arm, the arm 12 can operate at a normal operation speed. Therefore, it is possible to provide the robot system 1 with higher operation efficiency in which a decrease in production efficiency is curbed by changing an operation speed of the arm 12 according to an operation range of the arm 12.

### Embodiment 4

Embodiment 4 of the disclosure will be described below with reference to FIGS. 1, and 9A, 9B to 10. Here, for convenience of description, units having the same functions as the units described in the above embodiment will be denoted with the same reference numerals and descriptions thereof will be omitted.

### Configuration of Robot System

A configuration of the robot system 1 according to the present embodiment will be described with reference to FIG. 1.

A basic configuration of the robot system 1 is the same as that of Embodiment 3, but a part of the configuration is different. In the present embodiment, the robot system 1 further includes the moving subject position range monitoring unit 25.

The robot system 1 can determine using the moving subject position range monitoring unit 25 whether a moving subject such as an operator is present in a moving subject position range set outside the operation range of the arm 12 detected by the arm operation range detection unit 24. The robot system 1 can vary an operation speed of the arm 12 according to the determination result.

The moving subject position range monitoring unit 25 can monitor whether a moving subject such as an operator is present in a moving subject position range. The moving subject position range may be set at any position as long as it is outside the operation range of the arm 12, but it is set such that it includes a position at which an operator performs a routine operation. For example, the moving subject position range monitoring unit 25 may image a region including the moving subject position range using the camera 11 and determine whether the captured image includes a moving subject such as an operator.

### Positional Relationship Between Moving Subject Position Range and Operator

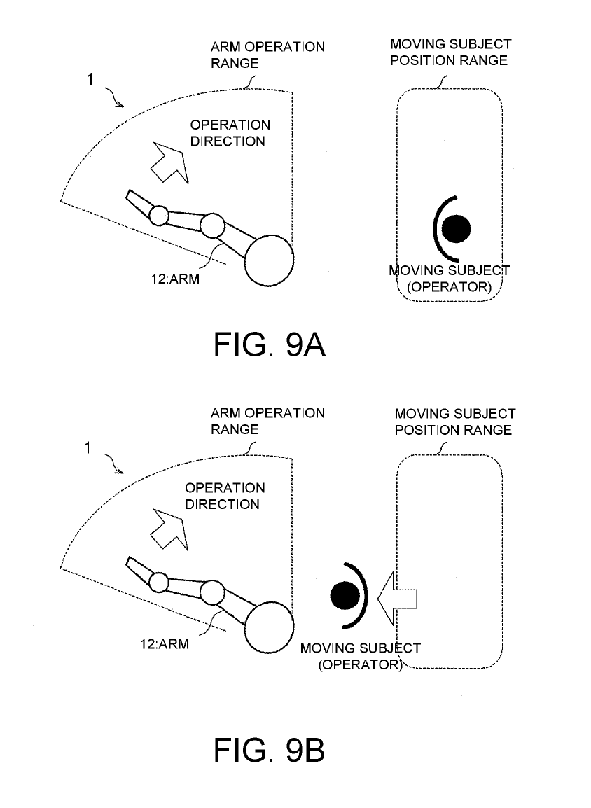

In the present embodiment, a positional relationship between a moving subject position range and an operator when the moving subject position range monitoring unit 25 monitors whether a moving subject is present will be described with reference to FIG. 9A and FIG. 9B. FIG. 9A and FIG. 9B shows bird's-eye views of the robot system 1 when viewed from above, FIG. 9A shows a case in which an operator is present in a moving subject position range, and FIG. 9B shows a case in which an operator has moved from inside to outside of the moving subject position range.

FIG. 9A shows a case in which a moving subject position range is set outside an operation range of the arm 12 and is set before the arm 12 moves according to an operation, and an operator who is a moving subject is present in the moving subject position range. When the moving subject position range monitoring unit 25 detects that an operator is present in the moving subject position range, the robot system 1 determines that there is no risk of the arm 12 colliding with the operator according to an operation of the arm 12. In this case, the arm operation control unit 22 can operate the arm 12 at a high speed in the same manner as usual.

FIG. 9B shows a case in which a moving subject position range is set outside an operation range of the arm 12 and is set before the arm 12 moves according to an operation, and an operator who is a moving subject has moved from inside to outside of the moving subject position range. When the moving subject position range monitoring unit 25 detects that no operator is present in the moving subject position range, the robot system 1 determines that there is a risk of the arm 12 colliding with the operator according to an operation of the arm 12. For example, when the operator present in the moving subject position range has moved outside of the moving subject position range and additionally moved into the operation range of the arm 12, there is a risk of the arm 12 colliding with the operator. In this case, the arm operation control unit 22 can set an operation speed of the arm 12 that is different from a normal speed.

According to the above configuration, the robot system 1 according to the present embodiment can operate the arm 12 at a high speed when an operator is present at a position at which a routine operation is performed and can operate the arm 12 at a low speed when an operator is away from the position at which a routine operation is performed according to a non-routine operation.

### Flow of Processes

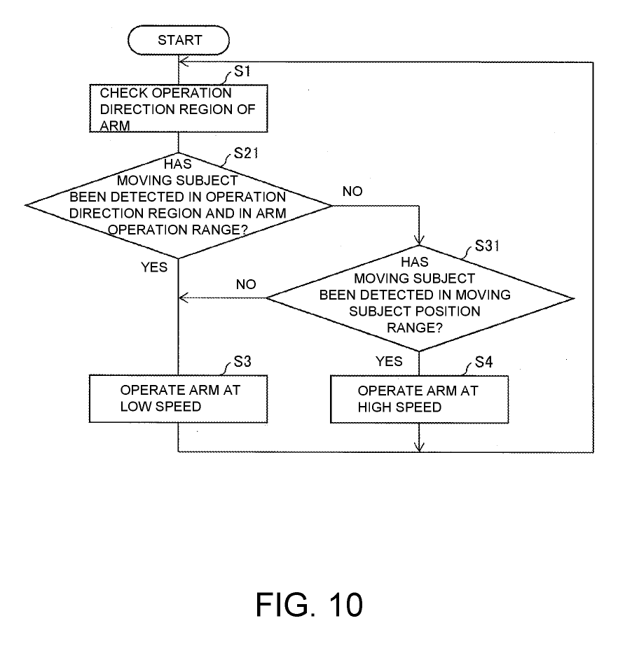

A flow of processes performed by the robot system 1 according to the present embodiment will be described with reference to FIG. 10. FIG. 10 is a flowchart showing an example of a flow of processes performed by the robot system 1.

The processes of S1 and S21 are the same as those in Embodiment 3. When it is determined in S21 that the control unit 20 has detected a moving subject (YES in S21), the arm operation control unit 22 performs the process of S3 in the same manner as in the above embodiment. After S3, the arm operation control unit 22 waits until the next operation of the arm 12 is input.

On the other hand, when it is determined in S21 that no moving subject has been detected (S21), the moving subject position range monitoring unit 25 determines whether a moving subject has been detected in the moving subject position range (S31). When it is determined that the moving subject has been detected in the moving subject position range (YES in S31), the arm operation control unit 22 performs the process of S4 in the same manner as in the above embodiment. After S4, the arm operation control unit 22 waits until the next operation of the arm 12 is input. When it is determined in S31 that no moving subject has been detected in the moving subject position range (NO in S31), the arm operation control unit 22 performs the process of S3 in the same manner as in the above embodiment. After S3, the arm operation control unit 22 waits until the next operation of the arm 12 is input.

According to the above configuration, when a moving subject such as an operator is not in the moving subject position range, the robot system 1 can operate the arm 12 at an operation speed that is different from an operation speed when an operator is in the moving subject position range. When an operator leaves the moving subject position range in which the operator performs an operation in a routine state, there is a risk of the operator accidentally entering the operation range of the arm. Therefore, when no operator is present in the moving subject position range, the arm 12 can operate at an operation speed that is different from a normal operation speed. Therefore, it is possible to provide the robot system 1 with higher safety through which, even during a non-routine operation when an operator is outside the moving subject position range, it is possible prevent collision with the operator in advance and operate the arm safely.

### Example of Implementation by Software

Control blocks (in particular, the moving subject detection unit 21 and the arm operation control unit 22) of the robot system 1 may be implemented by a logic circuit (hardware) formed in an integrated circuit (IC chip) and the like and may be implemented by software using a central processing unit (CPU).

In the latter case, the robot system 1 includes a CPU that executes an instruction of a program which is software for implementing functions, a read only memory (ROM) or a storage device (these are referred to as a “recording medium”) in which the program and various types of data that can be read by a computer (or a CPU) are recorded, a random access memory (RAM) that opens the program, and the like. Thus, when the computer (or a CPU) reads and executes the program from the recording medium, the disclosure is achieved. As the recording medium, “non-transitory tangible media,” for example, a tape, a disk, a card, a semiconductor memory, and a programmable logic circuit can be used. In addition, the program may be supplied to the computer through an arbitrary transmission medium (such as a communication network and broadcast waves) that can transmit the program. Here, in an embodiment of the disclosure, the program may be implemented in the form of a data signal combined with carrier waves embodied according to electronic transmission.

### SUMMARY

The robot system 1 according to Embodiment 1 of the disclosure includes the arm operation control unit 22 configured to control an operation of the arm 12 and the moving subject detection unit 21 configured to detect whether a moving subject is present in an operation direction region set according to an operation direction of the arm. The arm operation control unit is configured to, when the moving subject detection unit has detected the moving subject, operate the arm at an operation speed that is different from an operation speed of the arm when no moving subject has been detected.

According to the above configuration, when a moving subject, for example, an operator, is present in a direction in which the arm moves, the robot system can operate the arm at an operation speed that is different from an operation speed when no moving subject is present. Therefore, it is possible to set a time margin for the operator to move from the operation direction region, but when no operator is present in the operation direction region, it is possible to operate the arm at a normal speed. Therefore, it is possible to provide a robot system that maintains productivity with high safety and with high operation efficiency.

According to Embodiment 2 of the disclosure, in the robot system 1 in Embodiment 1, the operation direction region may be set such that it includes a target position of at least one arm described in a program (the operation program 31) that defines an operation of the arm 12.

According to the above configuration, when a moving subject such as an operator is present in the operation direction region that is set such that it includes a target position of the arm, the robot system can operate the arm at an operation speed that is different from an operation speed when no moving subject is present. In addition, when the operation direction region is set such that it includes at least one target position, the robot system can set a wider range of the operation direction region.

According to Embodiment 3 of the disclosure, in the robot system 1 in Embodiment 2, the operation direction region may be set by prefetching a target position of at least one arm described in the program (the operation program 31) that defines an operation of the arm 12 from a current step of a program that is executing an operation of the arm.

According to the above configuration, when at least one target position is set, before an operation of the arm moving toward each target position starts, the robot system can set an operation direction region including the target position. Therefore, when the program is used for prefetching, since it is possible to appropriately predict the next movement from a current position of the arm, it is possible to increase safety.

According to Embodiment 4 of the disclosure, the robot system 1 in any one of Embodiments 1 to 3 may further include the warning transmission unit 23 configured to transmit a warning to the outside, and, when the moving subject detection unit 21 has detected the moving subject, the warning transmission unit may transmit the warning.

According to the above configuration, the robot system transmits a warning to the outside when a moving subject such as an operator is present in a direction in which the arm moves. Therefore, the operator can move from a position in an operation direction of the arm on the basis of the warning. Therefore, it is possible to provide a robot system with high safety through which it is possible to prevent collision with the operator in advance.

According to Embodiment 5 of the disclosure, in the robot system 1 according to any one of Embodiments 1 to 3, when the moving subject detection unit 21 has detected the moving subject, the arm operation control unit 22 may stop an operation of the arm 12 or operate the arm 12 at a low speed.

According to the above configuration, when a moving subject such as an operator is present in a direction in which the arm moves, the robot system stops an operation of the arm or operates the arm at a low speed. Therefore, it is possible to provide a robot system with high safety through which it is possible to prevent collision with the operator in advance.

According to Embodiment 6 of the disclosure, in the robot system 1 in Embodiment 5, when an operation of the arm 12 is stopped or the arm 12 operates at a low speed, and then the moving subject detection unit 21 has not detected the moving subject in an operation direction of the arm, the arm operation control unit 22 may restart an operation of the arm in the operation direction or operate the arm at a normal speed.

According to the above configuration, when it is detected that a moving subject such as an operator is away from a position in an operation direction of the arm, the robot system restarts an operation of the arm or operates the arm at a normal speed. Therefore, it is possible to provide a robot system that has high safety and also continues an operation and obtains high operation efficiency.

According to Embodiment 7 of the disclosure, the robot system 1 in any one of Embodiments 1 to 6 further includes the arm operation range detection unit 24 configured to detect an operation range of the arm 12, and the moving subject detection unit 21 may detect whether the moving subject is present in the operation direction region and in the operation range of the arm.

According to the above configuration, when a moving subject such as an operator is present in an operation direction region of the arm and in an operation range of the arm, the robot system can operate the arm at an operation speed that is different from an operation speed when no operator is present. When an operator is present in the operation direction region of the arm but he or she is present outside the operation range, if the arm operates, since there is no risk of the operator colliding with the arm, the arm can operate at a normal operation speed. Therefore, it is possible to provide a robot system with higher operation efficiency in which a decrease in production efficiency is curbed by changing an operation speed of an arm according to an operation range of the arm.

According to Embodiment 8 of the disclosure, the robot system 1 according to any one of Embodiments 1 to 7 further includes the moving subject position range monitoring unit 25 configured to monitor whether the moving subject is present in a moving subject position range set outside an operation range of the aim 12, and when the moving subject position range monitoring unit has not detected the moving subject, the arm operation control unit 22 may operate the arm at an operation speed that is different from an operation speed of the arm when the moving subject position range monitoring unit has detected the moving subject.

According to the above configuration, when a moving subject such as an operator is not in the moving subject position range, the robot system can operate the arm at an operation speed that is different from an operation speed when an operator is in the moving subject position range. When an operator disappears in the moving subject position range in which the operator performs an operation in a routine state, there is a risk of the operator accidentally entering the operation range of the arm. Therefore, when no operator is present in the moving subject position range, the arm can operate at an operation speed that is different from a normal operation speed. Therefore, it is possible to provide the robot system with higher safety through which, even during a non-routine operation when an operator is outside the moving subject position range, it is possible prevent collision with the operator in advance and operate the arm safely.

According to Embodiment 9 of the disclosure, in the robot system 1 according to any one of Embodiments 1 to 8, the moving subject detection unit 21 may detect whether a moving subject is present in the operation direction region set according to an operation direction of the arm 12 on the basis of a captured image captured by the camera 11.

According to the above configuration, the robot system can detect whether a moving subject such as an operator is present in a direction in which the aim moves using a captured image of the camera. Therefore, when a moving subject is present in a direction in which the arm moves, it is possible to operate the arm at an operation speed that is different from an operation speed when no moving subject is present.

The disclosure is not limited to the above embodiments, and various modifications can be made within the scope of the claims, and embodiments obtained by appropriately combining technical methods disclosed in different embodiments are included in the technical scope of the disclosure.

What is claimed is:

1. A robot system comprising:
an arm operation control unit configured to control an operation of an arm; and
a moving subject detection unit configured to detect whether a moving subject is present in an operation direction region set according to an operation direction of the arm,
wherein, when the moving subject detection unit has detected the moving subject, the arm operation control unit operates the arm at an operation speed that is different from an operation speed of the arm when no moving subject has been detected.

2. The robot system according to claim 1,
wherein the operation direction region is set such that it includes a target position of at least one arm described in a program that defines an operation of the arm.

3. The robot system according to claim 2,
wherein the operation direction region is set by prefetching a target position of at least one arm described in the program that defines an operation of the arm from a current step of a program that is executing an operation of the arm.

4. The robot system according to claim 1, further comprising
a warning transmission unit configured to transmit a warning to the outside,
wherein, when the moving subject detection unit has detected the moving subject, the warning transmission unit transmits the warning.

5. The robot system according to claim 2, further comprising
a warning transmission unit configured to transmit a warning to the outside,
wherein, when the moving subject detection unit has detected the moving subject, the warning transmission unit transmits the warning.

6. The robot system according to claim 3, further comprising
a warning transmission unit configured to transmit a warning to the outside,
wherein, when the moving subject detection unit has detected the moving subject, the warning transmission unit transmits the warning.

7. The robot system according to claim 1,
wherein, when the moving subject detection unit has detected the moving subject, the arm operation control unit stops an operation of the arm or operates the arm at a low speed.

8. The robot system according to claim 2,
wherein, when the moving subject detection unit has detected the moving subject, the arm operation control unit stops an operation of the arias or operates the arm at a low speed.

9. The robot system according to claim 3,
wherein, when the moving subject detection unit has detected the moving subject, the arm operation control unit stops an operation of the arm or operates the arm at a low speed.

10. The robot system according to claim 7,
wherein, when an operation of the arm is stopped or the arm operates at a low speed and then the moving subject detection unit has not detected the moving subject in an operation direction of the arm, the arm operation control unit restarts an operation of the arm in the operation direction or operates the arm at a normal speed.

11. The robot system according to claim 1, further comprising
an arm operation range detection unit configured to detect an operation range of the arm,
wherein the moving subject detection unit detects whether the moving subject is present in the operation direction region and in an operation range of the arm.

12. The robot system according to claim 2, further comprising
an arm operation range detection unit configured to detect an operation range of the arm,
wherein the moving subject detection unit detects whether the moving subject is present in the operation direction region and in an operation range of the arm.

13. The robot system according to claim 3, further comprising
an arm operation range detection unit configured to detect an operation range of the arm,
wherein the moving subject detection unit detects whether the moving subject is present in the operation direction region and in an operation range of the arm.

14. The robot system according to claim 4, further comprising
an arm operation range detection unit configured to detect an operation range of the arm,
wherein the moving subject detection unit detects whether the moving subject is present in the operation direction region and in an operation range of the arm.

15. The robot system according to claim 7, further comprising
an arm operation range detection unit configured to detect an operation range of the arm,
wherein the moving subject detection unit detects whether the moving subject is present in the operation direction region and in an operation range of the arm.

16. The robot system according to claim 10, further comprising
an arm operation range detection unit configured to detect an operation range of the arm,
wherein the moving subject detection unit detects whether the moving subject is present in the operation direction region and in an operation range of the arm.

17. The robot system according to claim 1, further comprising
a moving subject position range monitoring unit configured to monitor whether the moving subject is present in a moving subject position range set outside an operation range of the arm,
wherein, when the moving subject position range monitoring unit has not detected the moving subject, the arm operation control unit operates the arm at an operation speed that is different from an operation speed of the arm when the moving subject position range monitoring unit has detected the moving subject.

18. The robot system according to claim 2, further comprising
a moving subject position range monitoring unit configured to monitor whether the moving subject is present in a moving subject position range set outside an operation range of the arm,
wherein, when the moving subject position range monitoring unit has not detected the moving subject, the arm operation control unit operates the arm at an operation speed that is different from an operation speed of the arm when the moving subject position range monitoring unit has detected the moving subject.

19. The robot system according to claim 3, further comprising
a moving subject position range monitoring unit configured to monitor whether the moving subject is present in a moving subject position range set outside an operation range of the arm,
wherein, when the moving subject position range monitoring unit has not detected the moving subject, the arm operation control unit operates the arm at an operation speed that is different from an operation speed of the arm when the moving subject position range monitoring unit has detected the moving subject.

20. The robot system according to claim 1,
wherein the moving subject detection unit detects whether a moving subject is present in the operation direction region set according to an operation direction of the arm on the basis of a captured image captured by a camera.
